(19) United States
(12) Patent Application Publication
(10) Pub. No.: US 2013/0112710 A1
(43) Pub. Date: May 9, 2013

(54) COOLING SYSTEM AND METHOD

(71) Applicant: Graco Minnesota Inc., Minneapolis, MN (US)

(72) Inventors: Daniel P. Ross, Maplewood, MN (US); Paul R. Quam, Brooklyn Center, MN (US)

(73) Assignee: GRACO MINNESOTA INC., Minneapolis, MN (US)

(21) Appl. No.: 13/671,038

(22) Filed: Nov. 7, 2012

Related U.S. Application Data
(60) Provisional application No. 61/556,571, filed on Nov. 7, 2011.

(51) Int. Cl. B67D 7/80; F24F 7/007; F24F 7/00; B05C 5/00

(52) U.S. Cl. CPC F24F 7/00; B05C 5/001; F24F 7/007
USPC 222/146.5; 454/254; 454/338

(57) ABSTRACT

A hot melt dispensing system includes a container for storing solid hot melt material, a melt system, a feed system for transporting solid hot melt material from the container to the melt system, a dispensing system for administering liquid hot melt material from the melt system, and removable insulating material positioned to enclose a portion of the melt system during a dispensing operation.

### CROSS-REFERENCE TO RELATED APPLICATION(S)

This application claims priority to U.S. Provisional Application No. 61/556,571, filed on Nov. 7, 2011 and entitled “HEATER TEMPERATURE RELIEF”.

### BACKGROUND

The present disclosure relates generally to systems for dispensing hot melt adhesive. More particularly, the present disclosure relates to a system and method for cooling parts of a hot melt dispensing system.

Hot melt dispensing systems are typically used in manufacturing assembly lines to automatically disperse an adhesive used in the construction of packaging materials such as boxes, cartons and the like. Hot melt dispensing systems conventionally comprise a material tank, heating elements, a pump and a dispenser. Solid polymer pellets are melted in the tank using a heating element before being supplied to the dispenser by the pump. Because the melted pellets will re-solidify into solid form if permitted to cool, the melted pellets must be maintained at temperature from the tank to the dispenser. This typically requires placement of heating elements in the tank, the pump and the dispenser, as well as heating any tubing or hoses that connect those components. Furthermore, conventional hot melt dispensing systems typically utilize tanks having large volumes so that extended periods of dispensing can occur after the pellets contained therein are melted. However, the large volume of pellets within the tank requires a lengthy period of time to completely melt, which increases start-up times for the system. For example, a typical tank includes a plurality of heating elements lining the walls of a rectangular, gravity-fed tank such that melted pellets along the walls prevents the heating elements from efficiently melting pellets in the center of the container. The extended time required to melt the pellets in these tanks increases the likelihood of “charring” or darkening of the adhesive due to prolonged heat exposure.

### SUMMARY

A hot melt dispensing system includes a container for storing solid hot melt material, a melt system, a feed system for transporting solid hot melt material from the container to the melt system, a dispensing system for administering liquid hot melt material from the melt system, and removable insulating material positioned to enclose a portion of the melt system during a dispensing operation.

A hot melt dispensing system has a melter with a heating element, where at least part of the melter is enclosed by a removable insulating material during a dispensing operation. A method for cooling the hot melt dispensing system includes shutting down the heating element, removing the removable insulating material that encloses the melter and directing a cooling airflow at the melter.

A hot melt dispensing system includes a container for storing solid hot melt material, a melt system, a feed system for transporting solid hot melt material from the container to the melt system, a dispensing system for administering liquid hot melt material from the melt system, and an air delivery system for delivering cooling air to the melt system in response to the melt system being turned off.

### BRIEF DESCRIPTION OF THE DRAWINGS

FIG. 1 is a schematic view of a system for dispensing hot melt adhesive.

FIG. 2A is a perspective view of a melt system within the system of FIG. 1 and removable insulation material enclosing part of the melt system.

FIG. 2B is an exploded view of the melt system of FIG. 2A showing separated insulation covers.

FIG. 3 is a perspective view of the melter of FIG. 2 with a cooling air delivery system.

FIG. 4 is a schematic view of a ducted melt system.

### DETAILED DESCRIPTION

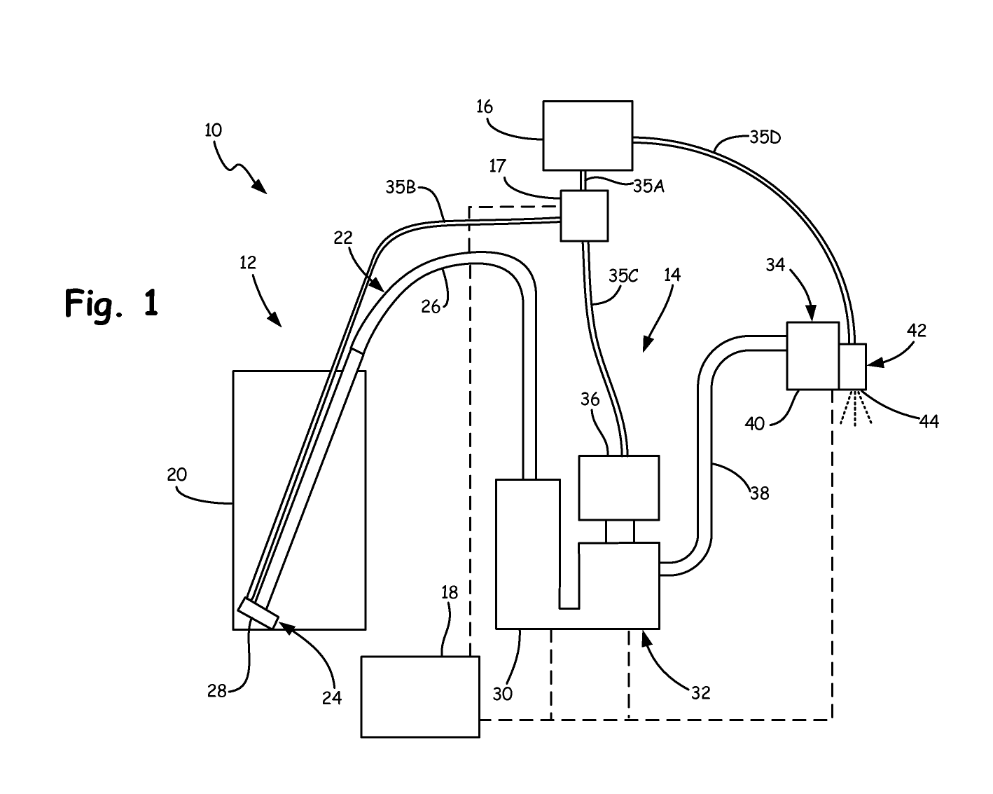

FIG. 1 is a schematic view of system 10, which is a system for dispensing hot melt adhesive. System 10 includes cold section 12, hot section 14, air source 16, air control valve 17, and controller 18. In the embodiment shown in FIG. 1, cold section 12 includes container 20 and feed assembly 22, which includes vacuum assembly 24, feed hose 26, and inlet 28. In the embodiment shown in FIG. 1, hot section 14 includes melt system 30, pump 32, and dispenser 34. Air source 16 is a source of compressed air supplied to components of system 10 in both cold section 12 and hot section 14. Air control valve 17 is connected to air source 16 via air hose 35A, and selectively controls air flow from air source 16 through air hose 35B to vacuum assembly 24 and through air hose 35C to motor 36 of pump 32. Air hose 35D connects air source 16 to dispenser 34, bypassing air control valve 17. Controller 18 is connected in communication with various components of system 10, such as air control valve 17, melt system 30, pump 32, and/or dispenser 34, for controlling operation of system 10.

Components of cold section 12 can be operated at room temperature, without being heated. Container 20 can be a hopper for containing a quantity of solid adhesive pellets for use by system 10. Suitable adhesives can include, for example, a thermoplastic polymer glue such as ethylene vinyl acetate (EVA) or metallocene-based hot melt adhesives. Feed assembly 22 connects container 20 to hot section 14 for delivering the solid adhesive pellets from container 20 to hot section 14. Feed assembly 22 includes vacuum assembly 24 and feed hose 26. Vacuum assembly 24 is positioned in container 20. Compressed air from air source 16 and air control valve 17 is delivered to vacuum assembly 24 to create a vacuum, inducing flow of solid adhesive pellets into inlet 28 of vacuum assembly 24 and then through feed hose 26 to hot section 14. Feed hose 26 is a tube or other passage sized with a diameter substantially larger than that of the solid adhesive pellets to allow the solid adhesive pellets to flow freely through feed hose 26. Feed hose 26 connects vacuum assembly 24 to hot section 14.

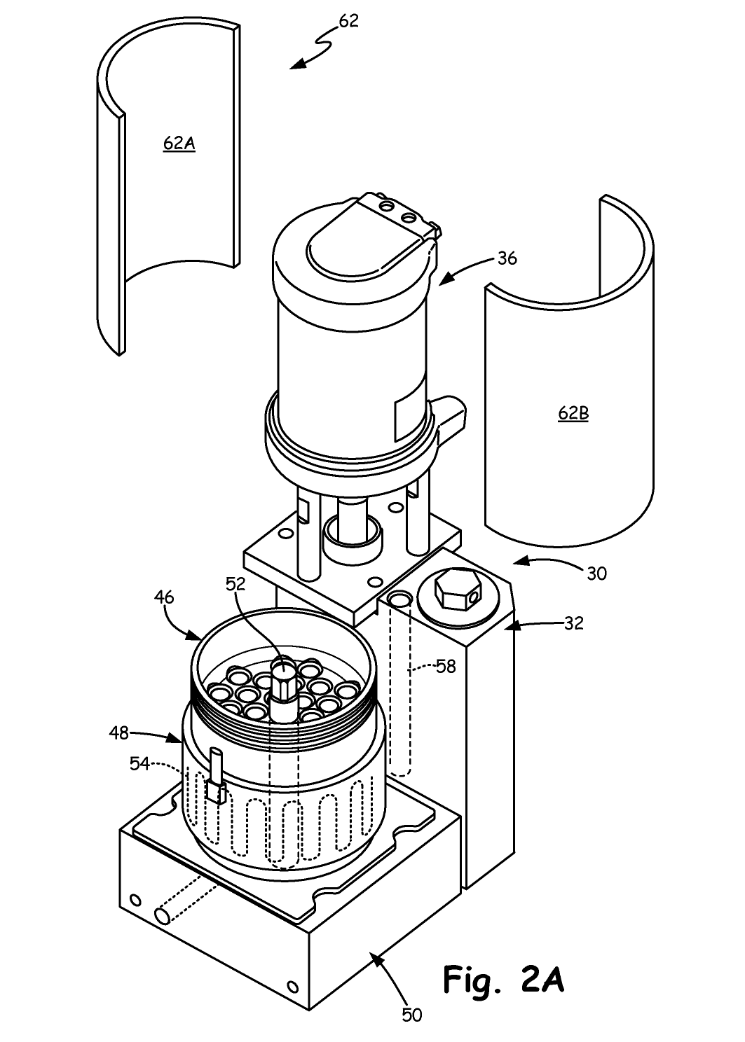

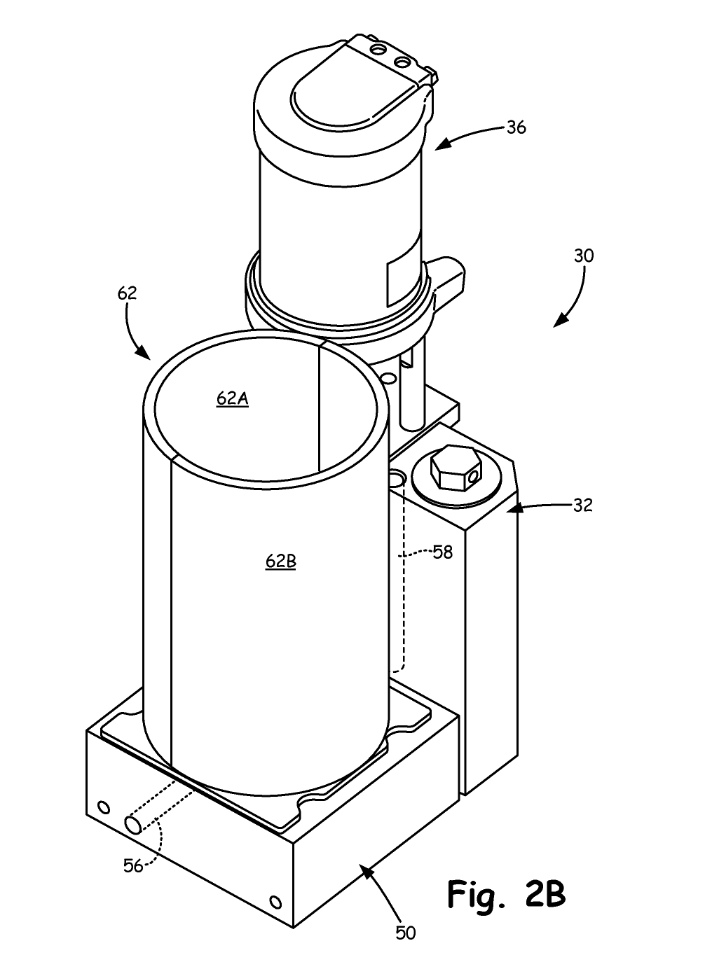

Solid adhesive pellets are delivered from feed hose 26 to melt system 30. Melt system 30 can include a container (melter 46, shown in FIG. 2B) and resistive heating elements (e.g., heater cartridge 52) for melting the solid adhesive pellets to form a hot melt adhesive in liquid form. Melt system 30 can be sized to have a relatively small adhesive volume, for example about 0.5 liters, and configured to melt solid adhesive pellets in a relatively short period of time. Pump 32 is driven by motor 36 to pump hot melt adhesive from melt system 30 to dispenser 34 through supply hose 38. Motor 36 can be an air motor driven by pulses of compressed air from air source 16 and air control valve 17. Pump 32 can be a linear displacement pump driven by motor 36. In the illustrated embodiment, dispenser 34 includes manifold 40 and module 42. Hot melt adhesive from pump 32 is received in manifold 40 and dispensed via module 42. Dispenser 34 can selectively discharge hot melt adhesive whereby the hot melt adhesive is sprayed out outlet 44 of module 42 onto an object, such as a package, a case, or another object benefiting from hot melt adhesive dispensed by system 10. Module 42 can be one of multiple modules that are part of dispenser 34. In an alternative embodiment, dispenser 34 can have a different configuration, such as a handheld gun-type dispenser. Some or all of the components in hot section 14, including melt system 30, pump 32, supply hose 38, and dispenser 34, can be heated to keep the hot melt adhesive in a liquid state throughout hot section 14 during the dispensing process.

System 10 can be part of an industrial process, for example, for packaging and sealing cardboard packages and/or cases of packages. In alternative embodiments, system 10 can be modified as necessary for a particular industrial process application. For example, in one embodiment (not shown), pump 32 can be separated from melt system 30 and instead attached to dispenser 34. Supply hose 38 can then connect melt system 30 to pump 32.

FIGS. 2A and 2B are perspective views of melt system 30. As shown in FIG. 2A, melt system 30 includes pump 32, motor 36, melter 46, band heater 48 and melter base 50. In FIG. 2A, a cap that normally is located on top of melter 46 has been removed so that internal features of melter 46 can be seen. Melter 46 is a melting vessel in which solid adhesive pellets are heated to form a hot melt adhesive in liquid form. Solid adhesive pellets enter melter 46 from a hopper (not shown) or feed hose 26. Melter 46 sits atop melter base 50 and can include features to increase the contact surface area within melter 46 such as channels, ribs and fins. Heat is supplied to melter 46 by an internal heating element and/or band heater 48. In the embodiment shown in FIG. 2A, heater cartridge 52 is located within melter 46 near the center of the melting vessel. Heater cartridge 52 can be a tube-shaped joule heating element. As current passes through heater cartridge 52, heat is transferred into melter 46. Alternatively, other types of heating elements can be located within melter 46.

Band heater 48 surrounds at least a portion of melter 46. As shown in FIG. 2A, melter 46 is generally cylindrical and band heater 48 is a cylindrical tube-like structure that surrounds melter 46. Band heater 48 includes a heating element. In the embodiment shown in FIG. 2A, resistive heating element 54 is embedded within band heater 48 (shown as dashed line 54). As current passes through resistive heating element 54, heat is transferred through band heater 48 and melter 46. Band heater 48 can extend upwards the from the bottom of melter 46 where melter 46 meets melter base 50 to cover all or a substantial portion of melter 46. Alternatively, band heater 48 can surround melter 46 generally only where solid adhesive pellets enter melter 46.

Melter base 50 is located below melter 46 and band heater 48. Melter base 50 contains a passageway (not shown) that allows melted liquid hot melt adhesive to travel from melter 46 to pump 32. Thus, once the hot melt adhesive has been melted in melter 46, it is delivered to pump 32 via melter base 50. Pump 32 then delivers the liquid hot melt adhesive to dispenser 34 as shown in FIG. 1. Melter base 50 is heated so that the liquid hot melt adhesive present in melter base 50 remains in liquid form and can flow to pump 32. In the embodiment shown in FIG. 2A, melter base 50 is heated by heater cartridge 56 that is inserted into melter base 50. FIG. 2A illustrates heater cartridge 56 within melter base 50. Heater cartridge 56 can be a tube-shaped joule heating element similar to heater cartridge 52.

As noted above, pump 32 pumps liquid hot melt adhesive from melt system 30 to dispenser 34. Pump 32 can include a heating element to supply heat to pump 32 to ensure that any liquid hot melt adhesive present in pump 32 remains in liquid form. In the embodiment shown in FIG. 2A, pump 32 is heated by heater cartridge 58 that is inserted into pump 32. FIG. 2A illustrates heater cartridge 58 within pump 32. Heater cartridge 58 can be a tube-shaped joule heating element similar to heater cartridges 52 and 56.

Insulation can be used to better maintain the operating temperature of melt system 30 during dispensing and prevent undesired heat transfer to operators and other components of system 10. However, once a dispensing operation has been completed, insulated components of melt system 30 can retain heat for a long period of time. Cooling melt system 30 quickly and with little expense can improve operator safety and reduce the likelihood of damage to components in the vicinity of melt system 30.

In addition to melt system 30, FIGS. 2A and 2B also illustrate removable insulating material 62 arranged according to one embodiment of the invention. As shown in FIGS. 2A and 2B, insulating covers (or panels) 62A and 62B are positioned around and circumferentially enclose melter 46 and band heater 48. FIG. 2A shows as exploded view with covers 62A and 62B separated while FIG. 2B shows removable insulating material 62 (covers 62A and 62B) in place around melter 46 and band heater 48. Insulating covers 62A and 62B help keep melt system 30 at an elevated temperature during the dispensing operation. Covers 62A and 62B can be connected together to form an insulating sleeve that is mounted around melter 46 and band heater 48. Utilizing insulating material 62 reduces heat loss by melt system 30, reducing the amount of power needed for actively heating melt system 30. While FIG. 2 illustrates an embodiment in which two insulating covers are used as removable insulating material 62, removable insulating material 62 can be a single insulating structure or a combination of three or more insulating structures.

Removable insulating material 62 (including insulating covers 62A and 62B) can be composed of any material having an adequately low thermal conductivity. Suitable materials for removable insulating material 62 include, but are not limited to, aerogels, mineral or glass wools, flexible elastomeric foams, rigid foam insulation and combinations thereof. Removable insulating material 62 can be rigid or flexible depending on the location of removable insulating material 62.

Once the dispensing operation has ended, removable insulating material 62 can be removed from system 10 to allow melt system 30 to cool more rapidly. Insulating covers 62A and 62B can be easily removed from melt system 30 by separating insulating cover 62A from insulating cover 62B and removing any connection to melt system 30. When enclosing melter 46 and band heater 48, insulating covers 62A and 62B can be joined to one another or to melter 46 or band heater 48 to ensure that covers 62A and 62B remain in place. Insulating covers 62A and 62B can be joined together or to components of melt system 30 using any fasteners able to withstand the operating temperatures of melt system 30. For example, covers 62A and 62B can be joined together in a clamshell configuration to facilitate installation and removal.

FIGS. 2A and 2B show removable insulating material 62 enclosing melter 46 and band heater 48. In other embodiments, removable insulating material 62 encloses melter base 50 in addition to melter 46 and band heater 48. In still other embodiments, removable insulating material 62 encloses pump 32 in addition to melter base 50, melter 46 and band heater 48. As noted above, in these embodiments, removable insulating material 62 can be a single insulating structure, such as a cylindrical sleeve, or a combination of two or more insulating structures.

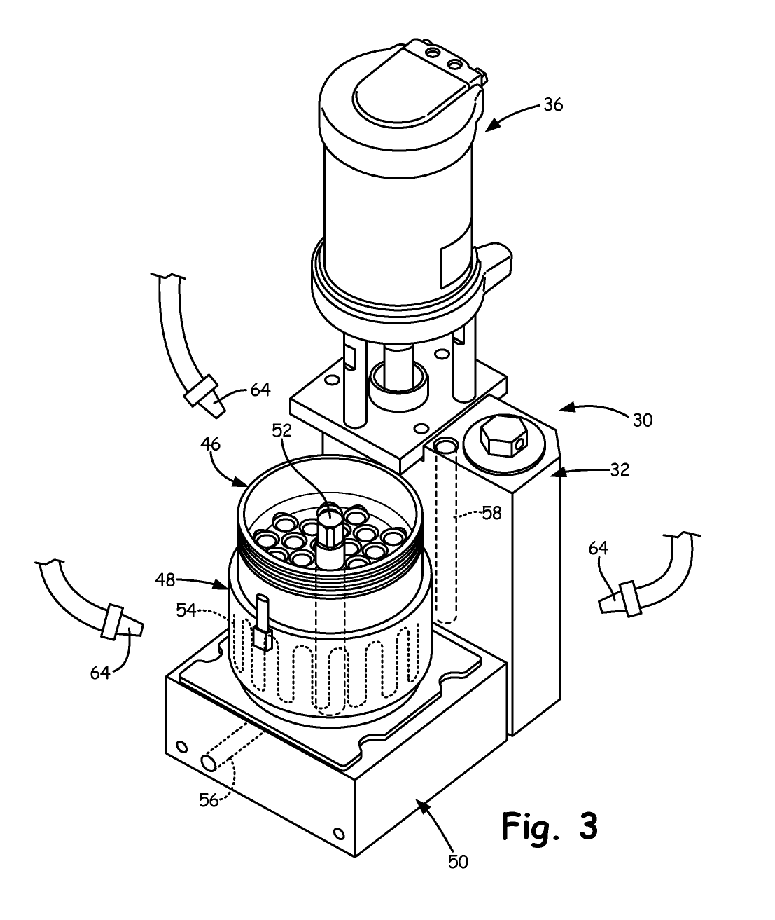

Melt system 30 can also be cooled with cooling air from an air delivery system. FIG. 3 is a perspective view of melt system 30 illustrating cooling air outlets 64. Cooling air outlets 64 can be positioned around melt system 30 to direct air at melter 46, band heater 48, melter base 50, pump 32 and combinations thereof. Cooling air outlets 64 can communicate with air source 16 (shown in FIG. 1), another source of compressed air or another air source. Once system 10 has finished operating, controller 18 can command delivery of cooling air from cooling air outlets 64 to cool melt system 30. The delivery of cooling air from cooling air outlets 46 can be used alone or in conjunction with the removal of removable insulating material 62.

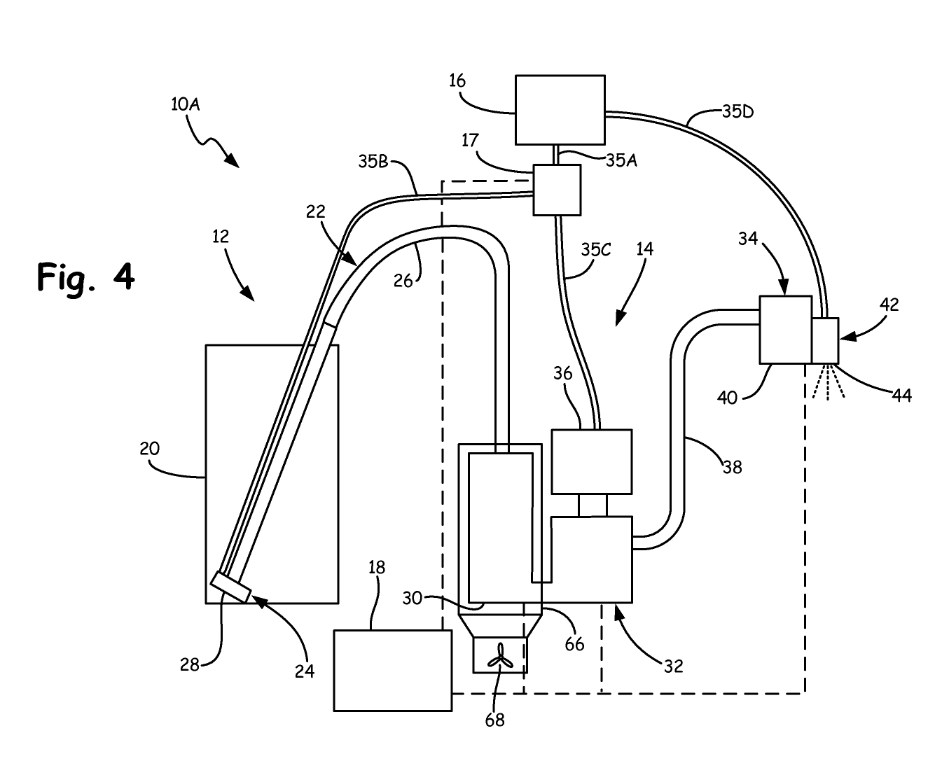

In another embodiment, melt system 30 can be positioned within a duct that communicates with an air moving device (e.g., fan). FIG. 4 is a schematic view of system 10A in which melt system 30 is located within duct 66. Fan 68 communicates with duct 66 and can deliver cooling air to cool melt system 30 following operation. Duct 66 can enclose just melt system 30 as shown in FIG. 4. Alternatively, duct 66 can enclose melt system 30 as well as pump 32 and motor 36. Once system 10 has finished operating, controller 18 can command delivery of cooling air from fan 68 to cool melt system 30 and any other components within duct 66. The delivery of cooling air from fan 68 can be used alone or in conjunction with the removal of removable insulating material 62.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A hot melt dispensing system comprising:
a container for storing solid hot melt material;
a melt system;
a feed system for transporting solid hot melt material from the container to the melt system;
a dispensing system for administering liquid hot melt material from the melt system; and
removable insulating material positioned to enclose a portion of the melt system during a dispensing operation.

2. The hot melt dispensing system of claim 1, wherein the melt system comprises:
a melter for heating solid hot melt material into a liquid;
a band heater surrounding at least a portion of the melter;
a pump for delivering liquid hot melt material; and
a melter base located between the melter and the pump that allows liquid hot melt material to flow from the melter to the pump;

3. The hot melt dispensing system of claim 2, wherein the removable insulating material comprises an insulating cover that encloses the melter and the band heater during the dispensing operation.

4. The hot melt dispensing system of claim 3, wherein the insulating cover encloses the melter base during the dispensing operation.

5. The hot melt dispensing system of claim 4, wherein the insulating cover encloses the pump during the dispensing operation.

6. The hot melt dispensing system of claim 1, wherein the removable insulating material comprises two or more separable insulating covers.

7. The hot melt dispensing system of claim 1, further comprising:
a compressed air delivery system for directing cooling air at the melt system once the removable insulating material has been removed.

8. The hot melt dispensing system of claim 1, further comprising:
a duct, wherein the melt system is positioned within the duct; and
an air moving device in communication with the duct for delivering cooling air to the melt system.

9. A method for cooling a hot melt dispensing system having a melter with a heating element, at least part of the melter enclosed by a removable insulating material during a dispensing operation, the method comprising:
shutting down the heating element;
removing the removable insulating material that encloses the melter; and
directing a cooling airflow at the melter.

10. The method of claim 9, wherein directing the cooling airflow at the melter comprises directing air from a compressed air source.

11. The method of claim 10, wherein the compressed air source also powers a motor that drives a pump in the hot melt dispensing system.

12. The method of claim 9, wherein the melter is positioned within a duct, and wherein directing the cooling airflow at the melter comprises generating an airflow with an air moving device in communication with the duct.

13. A hot melt dispensing system comprising:
a container for storing solid hot melt material;
a melt system;
a feed system for transporting solid hot melt material from the container to the melt system;
a dispensing system for administering liquid hot melt material from the melt system; and
an air delivery system for delivering cooling air to the melt system in response to the melt system being turned off.

14. The hot melt dispensing system of claim 13, wherein the melt system comprises:
a melter for heating solid hot melt material into a liquid;
a band heater surrounding at least a portion of the melter;
a pump for delivering liquid hot melt material; and
a melter base located between the melter and the pump that allows liquid hot melt material to flow from the melter to the pump;

15. The hot melt dispensing system of claim 13, wherein the air delivery system includes a compressed air source for providing cooling air.

16. The hot melt dispensing system of claim 13, wherein the melt system is positioned within a duct, and the cooling air is delivered by an air moving device that communicates with the duct.

17. The hot melt dispensing system of claim 13, further comprising:
a removable insulating material positioned to enclose a portion of the melt system during a dispensing operation.

18. The hot melt dispensing system of claim 17, wherein the removable insulating material comprises two or more separable insulating covers.

19. The hot melt dispensing system of claim 13, further comprising:
a removable insulating material positioned to enclose a portion of the melt system during a dispensing operation, wherein the removable insulating material comprises an insulating cover that encloses the melter and the band heater during the dispensing operation.
